(19) United States
(12) Patent Application Publication
(10) Pub. No.: US 2012/0083292 A1
(43) Pub. Date: Apr. 5, 2012

(54) MOBILE PHONE COMPRISING ANTITHEFT FUNCTION AND ANTITHEFT METHOD THEREOF

(75) Inventors: Yoon Suk YEO, Seoul (KR); Sang Hoon Kim, Bucheon-si (KR)

(73) Assignee: SECUAPP Co., Ltd., Bucheon-si (KR)

(21) Appl. No.: 13/050,145

(22) Filed: Mar. 17, 2011

(30) Foreign Application Priority Data
Sep. 30, 2010 (KR) 10-2010-0095160

(51) Int. Cl. H04W 12/00; H04W 64/00

(52) U.S. Cl. 455/456.6

(57) ABSTRACT

A mobile phone with antitheft function and an antitheft method thereof are provided. The mobile phone enters antitheft mode if the mobile phone has not been moved outside a user's registered geographical range for more than a predetermined time period and outputs an alarm sound and transmits current location information and images photographed around the mobile phone if detecting a movement of the mobile phone so that a user can easily locate his mobile phone. Furthermore, the mobile phone does not allow anyone other than the user to move or use the mobile phone, and photographs the attempter, carries out face recognition based on the photographed image and outputs a predetermined alarm message.

### CROSS-REFERENCE TO RELATED APPLICATIONS

This application claims priority from Korean Patent Application No. 10-2010-0095160, filed on Sep. 30, 2010, in the Korean Intellectual Property Office, the disclosure of which is incorporated herein by reference in its entirety.

### BACKGROUND

1. Field of the Invention

The invention relates to a mobile phone with an antitheft function and an antitheft method thereof with which it is easy to locate a lost or stolen mobile phone by using a GPS receiver built in the mobile phone.

2. Description of the Related Art

One of the most revolutionary information devices that came to the portable possession of individuals in accordance with the advancement of IT technology is the mobile phone. Recently, smartphones—mobile phones with a variety of hardware and software functionalities, have been developed.

Since the mobile phone keeps individual network of a user, the user always carries around rather than keeping it in a safe place. Accordingly, there always is the possibility of lost of mobile phone or stealing of lost phones. In fact, millions of mobile phones are lost or stolen every year.

It is reported that among those phones that are lost, no more than 10% are recovered.

### SUMMARY

Exemplary embodiments of the present inventive concept overcome the above disadvantages and other disadvantages not described above. Also, the present inventive concept is not required to overcome the disadvantages described above, and an exemplary embodiment of the present inventive concept may not overcome any of the problems described above.

According to one embodiment, a mobile phone with antitheft function and an antitheft method thereof are provided, in which it is easy to locate a lost or stolen mobile phone using a GPS receiver built in the mobile phone.

In one embodiment, a mobile phone which is connected to a mobile communication network and provides a mobile communication service is provided, which may include a global positioning system (GPS) receiver which generates current location information of the mobile phone, a movement detecting unit which generates movement information and posture information of the mobile phone, a built-in camera which photographs in a forward direction, a storage medium which stores information regarding a user's registered geographical range, an antitheft unit which enters antitheft mode if the current location information received from the GPS receiver is outside the user's registered geographical range and if the mobile phone is not moved for a first set time based on determination of the information provided by the movement detecting unit, and releases the antitheft mode if a predetermined release command is received from a user, and a data processing unit which transmits to a user side the location information received from the GPS receiver and images photographed by the camera at interval of a second set time during the antitheft mode.

In some embodiments, the data processing unit generates a map image using map data stored in the storage medium, in which a location corresponding to the location information is indicated on the map image, and transmits the generated map image to the user side instead of the location information.

Furthermore, the antitheft unit outputs a predetermined alarm sound if determining that the mobile phone is moving based on the information provided by the movement detecting unit during the antitheft mode.

In the above example, the antitheft unit may determine if the mobile phone is within a set angle range based on determination of the information provided by the movement detecting unit during the antitheft mode, and if the mobile phone is determined to be positioned within the set angle range, the data processing unit causes the camera to photograph in a forward direction, carries out image processing on the photographed images and stores in the storage medium an image from which facial information is detected.

In some embodiments, the mobile phone may additionally include an operation starting unit which generates an event which controls so that the antitheft unit is called to start operating, if a call is connected to a preset sender telephone number or a text message including a preset text string is received from the sender telephone number. The antitheft unit does not constantly operate but initiate operation in response to the event.

In another embodiment, an antitheft method of a mobile phone which is connected to a mobile communication network and provides a mobile communication service, is provided, which may include (step 1) entering antitheft mode if current location information received from a GPS receiver is outside a user's registered geographical range and if the mobile phone is not moved for a first set time based on determination of information provided by a built-in movement detecting unit, and maintaining the antitheft mode until a predetermined release command is received from a user, and (step 2) transmitting to a user side the location information received from the GPS receiver and images photographed by a built-in camera at interval of a second set time during the antitheft mode.

According to an embodiment, the mobile phone enters antitheft mode if the mobile phone is not moved for more than a predetermined time outside a user's registered geographical range, and outputs an alarm sound to prevent moving or use of the mobile phone by outputting an alarm sound, if detecting a movement of the mobile phone during the antitheft mode.

Furthermore, the mobile phone transmits to a user side location information thereof and images photographed therearound so that the user can determine the location of the mobile phone using the location information, and infer the place where the mobile phone is, based on the transmitted images.

Furthermore, in providing the location information, the mobile phone may provide the user side with a map image on which the coordinates acquired through the GPS receiver are indicated, so that the user can instantly determine the location of the mobile phone.

If anyone other than the user attempts to use the mobile phone, the mobile phone photographs the unauthorized user and provides a predetermined message or alarm message based on the photographed images, to thus advise the unauthorized user to return the mobile phone to the user. The image processing may be carried out regarding the corresponding photographed images so that a face is detected and the detected face is included in the photographed image.

### BRIEF DESCRIPTION OF THE DRAWINGS

The above and/or other aspects of the present inventive concept will be more apparent by describing certain exemplary embodiments of the present inventive concept with reference to the accompanying drawings, in which:

FIG. 1 is a block diagram of a mobile phone according to an embodiment; and

FIG. 2 is a flowchart provided to explain an antitheft function of a mobile phone according to an embodiment.

### DETAILED DESCRIPTION OF EXEMPLARY EMBODIMENTS

Certain exemplary embodiments of the present inventive concept will now be described in greater detail with reference to the accompanying drawings.

In the following description, same drawing reference numerals are used for the same elements even in different drawings. The matters defined in the description, such as detailed construction and elements, are provided to assist in a comprehensive understanding of the present inventive concept. Accordingly, it is apparent that the exemplary embodiments of the present inventive concept can be carried out without those specifically defined matters. Also, well-known functions or constructions are not described in detail since they would obscure the invention with unnecessary detail.

A mobile phone 100 in one embodiment is a device that basically accesses a mobile communication network and provides mobile communication service. The mobile phone 100 may be constructed in a known-manner to provide such basic function. Accordingly, unless necessary, the construction of the mobile phone 100 to provide basic mobile communication service will not be explained or shown in the drawing for the sake of brevity.

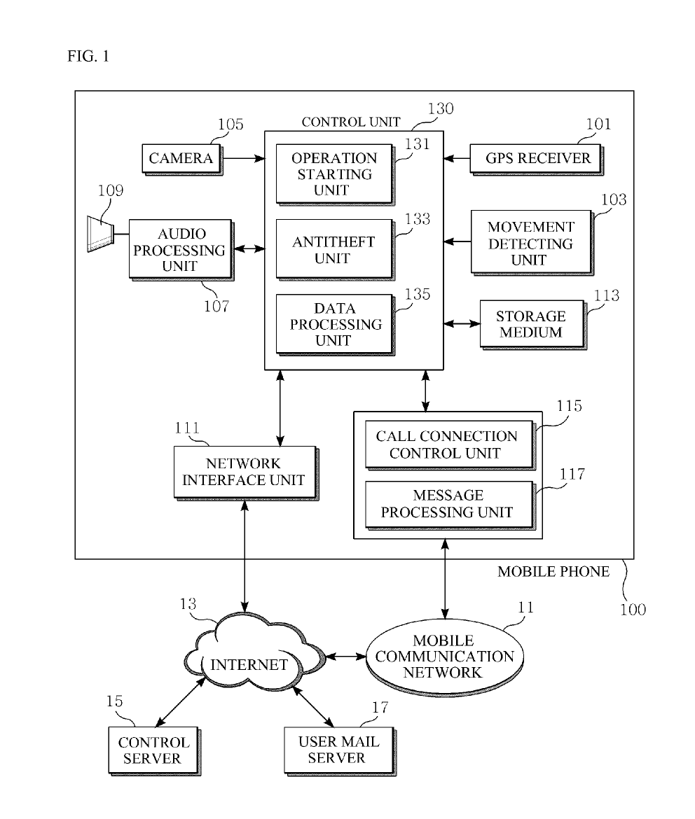

Accordingly, the constitution of the mobile phone 100 illustrated in FIG. 1 may be separately constructed from the construction to provide the known mobile communication service and included in the mobile phone 100 according to an embodiment, or may be similar to the construction to provide the known mobile communication service on a hardware level but provide different functions.

Referring to FIG. 1, the mobile phone 100 according to an embodiment may include a GPA receiver 101, a movement detecting unit 103, a camera 105, an audio processing unit 107, a speaker 109, a network interface unit 111, a storage medium 113, a call connection control unit 115, a message processing unit 117 and a control unit 130. Among these, the call connection control unit 115 and the message processing unit 117 are related to general telephoning function, which access a mobile communication network 11 and provides audio/video/data communication.

The mobile phone 100 may access a control server 15 or a user mail server 17 via the internet 13 by using the network interface unit 111.

The GPS receiver 101 acquires location information (e.g., longitudes or latitudes) of a location on earth where the mobile phone 100 is placed and provides the acquired information to the control unit 130. The GPS receiver 101 generates location information by receiving a predetermined signal that corresponds to the location information from a GPS satellite or transmitter on earth.

The GPS receiver 101 may desirably receive predetermined data from a GPS satellite and output coordinate values on WGS-84 (World Geodetic System, 1984) coordinate system, and in this case, the location information may be the coordinate values on the WGS-84 coordinate system of the mobile phone 100.

The movement detecting unit 103 may detect information as to the movement or posture of the mobile phone 100 and output the detected result to the control unit 130. The control unit 130 may compute movement of the mobile phone 100 or the posture of the mobile phone 100 using the information provided by the movement detecting unit 103. By way of example, the movement detecting unit 103 may use a three-axis (x, y, z) accelerometer sensor and the control unit 130 may compute the possible movement or posture of the mobile phone 100 using the acceleration values at the respective axes as measured by the three-axis accelerometer sensor.

The camera 105 is built in the mobile phone 100 to photograph objects in front and/or rear direction and provide the photographed images to the control unit 130.

The audio processing unit 107 may be provided to an existing mobile communication service according to the control of the control unit 130, and may additionally output various audio signals through a speaker 109 as one of antitheft functions according to an embodiment.

The network interface unit 111 may include a wired local area network (LAN) or wireless LAN interface to access the internet 13.

The storage medium 113 may be a built-in or removable memory, and store therein information regarding user's registered geographical range, information regarding user, map data to indicate the location information generated at the GPS receiver 101, or information regarding various settings related to the antitheft function according to an embodiment which will be explained in detail below. The information regarding the user may include user's e-mail address, or address of a separate control server 15 that provides anti-lost or anti-theft service.

As explained above, the call connection control unit 115 and the message processing unit 117 are accessible to the mobile communication network 11 so as to carry out general conventional telephoning function, but is particularly shown the relationship with the control unit 130 among the overall construction for call connecting and messages sending in FIG. 1.

The call connection control unit 115 carries out a general telephoning function of the mobile phone 100 to access the mobile communication network 11 and send out or receive calls, and connect a call to the received call.

The message processing unit 117 receives or sends out a short message service (SMS) or multimedia message service (MMS) of the mobile phone 100.

The control unit 130 controls the overall operation of the mobile phone 100 according to an embodiment. As explained above, the basic function of the mobile phone 100 will not be explained in detail, but the construction with the characteristic functions of an embodiment will be particularly explained.

The control unit 130 may include an operation starting unit 131, an antitheft unit 133 and a data processing unit 135 to provide anti-lost or antitheft function.

The control unit 130 may have a functional construction including a processor chip, which is a basic hardware of the mobile phone 100, and programs operating by the processor chip. Accordingly, the mobile phone 100 may include an operating system (OS) which is basically installed in a general conventional mobile phone and carried out by the processor chip, and application programs installed based on the OS program to control the hardware construction inside the mobile phone 100 and carry out various functions of the mobile phone 100.

In the above example, the operating starting unit 131, the antitheft unit 133 and the data processing unit 135 may be at least one application program that is installed in the mobile phone 100 as software which is written in a program language interpretable by a computer so that a series of designated commands thereof can be processed.

The operation starting unit 131 controls the antitheft unit 133 to start the operation. That is, in some circumstances, the operation starting unit 131 generates an event to cause the antitheft unit 133 to start the operation. If the operation starting unit 131 generates the event, the antitheft unit 133 performs anti-lost or antitheft function according to an embodiment. To be specific, the event may include an operation of the operation starting unit 131 to call the antitheft unit 133.

In some embodiments, the antitheft unit 133 may be set to operate continuously while the main power of the mobile phone 100 is on. In these cases, the operation starting unit 131 may not be an essential component.

Various conditions may be set to cause the operation starting unit 131 to generate an event.

By way of example, if the message processing unit 117 receives short message service (SMS) message or multimedia message and provides the received message along with the sender's number to the operation starting unit 131, the operation starting unit 131 may call the antitheft unit 133 if the sender's number received from the message processing unit 117 corresponds to a preset telephone number and if the received message corresponds to a preset message (e.g., specific text string). The ‘preset sender's telephone number’ herein may be the telephone number which is being used by the user or the user side, except that of the mobile phone 100.

In another embodiment, the operation starting unit 131 may call the antitheft unit 133 if a request for connecting a call is received from the preset telephone number and the call is connected to the subscriber of the corresponding telephone number. To this end, the operation starting unit 131 may receive information about the reception and connection of a call from the call connection control unit 115. Likewise, the preset telephone number herein may be different from that of the mobile phone 100 but belongs to the user side.

In yet another embodiment, the operation starting unit 131 may call the antitheft unit 133 when receiving an operation start command from the control server 15 via the internet 13 and the network interface 111.

Depending on setting, the antitheft unit 133 may continuously operate as long as the main power of the mobile phone 100 is on, or alternatively, starts operating in connection with an event generated by the operation starting unit 131, to perform the anti-lost or antitheft function by determining if the operation enters antitheft mode and providing the data processing unit 135 with information regarding the antitheft mode.

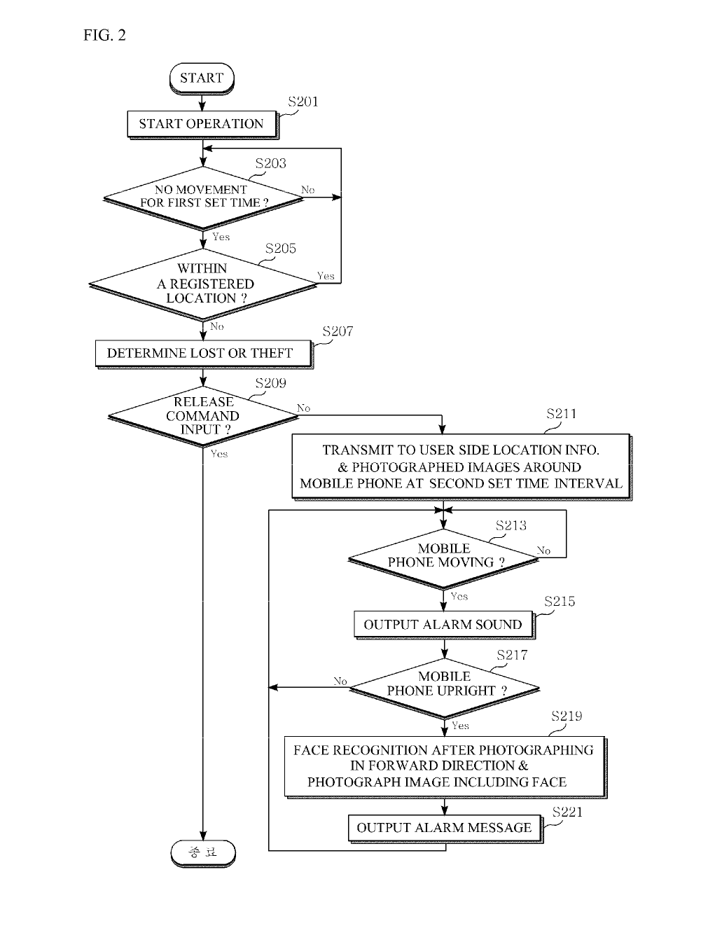

The antitheft unit 133 determines that it is anti-lost or antitheft state and accordingly enters into the antitheft mode, if no movement of the mobile phone 100 is detected for more than a predetermined time period outside the user's registered geographical range stored in the storage medium 113. The operation of the antitheft unit 133 will be explained below with reference to FIG. 2.

If the data processing unit 135 receives the information about the antitheft mode from the antitheft unit 133, the data processing unit 135 transmits to the user side the location information of the mobile phone 100 and images photographed around the mobile phone 100 at predetermined time intervals until the antitheft mode is released. To this end, the data processing unit 135 receives the location information from the GPS receiver 101. Further, the data processing unit 135 controls the camera 105 to photograph around the mobile phone 100 and receives the photographed images.

Further, if the data processing unit 135 receives a command to detect facial information from the antitheft unit 133, the data processing unit 135 controls the camera 105 to photograph in a forward direction and detects facial information from the photographed images.

An anti-lost or antitheft method according to an embodiment will be explained below with reference to FIG. 2, mainly with reference to the operation at the antitheft unit 133.

At S201, as the operation starting unit 131 calls the antitheft unit 133 in an event-driven manner in response to a user's command to control the operation start, or the like, the antitheft unit 133 starts operating. As explained above, the operation starting unit 131 may start the operation in response to the user's operation start command or push alarm.

At S203, the antitheft unit 133 starts operating and enters into the monitoring mode in which the antitheft unit 133 monitors movement of the mobile phone 100 based on the information of the movement detecting unit 103 and detects to determine if movement ha snot been detected for more than first set-time. The ‘first set-time’ herein may be set randomly according to selection by the user. The state that ‘no movement is detected’ refers to a situation in which the mobile phone 100 is placed somewhere.

At S205, if no movement is detected for first set-time, the antitheft unit 133 determines if the current location information received from the GPS receiver 101 is within the user's registered geographical range stored in the storage medium 113. The user's registered geographical range may refer to a geographical range such as user's home or office which is controllable by the user. The user's registered geographical range is set by the user. If determining that the mobile phone is in the user's registered geographical range, the antitheft unit 203 returns to operation at S203 and monitors to determine if the mobile phone 100 turns to a stationary state again.

At S207, if the determination at S205 indicates that the current location is outside the registered geographical range, the antitheft unit 133 determines that the mobile phone 100 is lost or stolen and thus enters into the antitheft mode.

At S209, the antitheft unit 133 in antitheft mode monitors to determine if a user inputs a release command. The ‘release command’ may include inputting of a preset password or pass code. Further, the user's release command may be inputted in any stage of the antitheft mode, and upon receiving the release command, the antitheft unit 133 releases from the antitheft mode.

At S211, in the absence of the release command, the antitheft unit 133 transmits information about the antitheft mode to the data processing unit 135 to request the data processing unit 135 to provide the first transmission of the current location information and images photographed around the mobile phone 100 to the user side. In response to receiving from the antitheft unit 133 the information indicating that the antitheft unit 133 enters antitheft mode, the data processing unit 135 receives the current location information from the GPS receiver 101, receives images photographed by the camera 105 in forward and/or backward directions and provides the photographed images to the user side. Furthermore, the data processing unit 135 keeps providing the user side with the newly-acquired location information and images at intervals of second set-time until the antitheft mode release information is received.

At S213, considering that fact that a movement of the mobile phone 100 in the antitheft unit can indicate that the theft is happening, the antitheft unit 133 determines based on the information provided by the movement detecting unit 130 whether the mobile phone 100 is moved or not.

At S215, if the determination at S213 indicates that the mobile phone 100 is moving, the antitheft unit 133 controls the audio processing unit 107 to output an alarm sound. The audio processing unit 107 may output a predetermined alarm sound through a speaker 109. The alarm sound is continuously outputted as long as the movement is detected.

S217, next, the antitheft unit 133 determines if the mobile phone 100 is in upright position. The antitheft unit 133 determines the posture of the mobile phone 100 using the information provided by the movement detecting unit 103, and if determining that the mobile phone 100 is within a predetermined angle range, determines that the mobile phone 100 is in upright position.

At S219, if the determination at S217 indicates that the mobile phone 100 is in upright position, the antitheft unit 133 requests the data processing unit 135 to photograph images and detect the information of a human face based on the photographed images. Accordingly, the data processing unit 135 controls the camera 105 to photograph in a forward direction, carries out image processing for facial recognition based on the photographed images and thus detects the facial information. If not facial information is detected, the data processing unit 135 controls the camera 105 to photograph new images and stores the images from which face is recognized to a memory.

At S221, if the images from which face is detected is stored, the antitheft unit 133 a predetermined message may be outputted through an LCD window or the speaker 109. For example, the message may include a statement advising that the photographs have been taken and the mobile phone 100 should be returned to the user side.

The operations from S213 to S221 may repeat during the antitheft mode. As a result, the antitheft function of the mobile phone 100 is achieved.

As explained above, the release command of the user at S219 may be inputted in any stage other than S209 in the antitheft mode, upon receipt of which the antitheft unit 133 releases the antitheft mode and thus skips the operation after S211.

In some embodiments, the user may not immediately recognize the location of the mobile phone 100 by the location information (longitude and altitude) provided by the data processing unit 135 at S211. In this case, a separate device is necessary, which indicates the location of the mobile phone 100 on a map using the corresponding location information.

Accordingly, upon receiving the location information from the GPS receiver 101, the data processing unit 135 may extract a part of a map corresponding to the received location information from the map data stored at the storage medium 113, generates a map image with the location corresponding to the location information indicated thereon, and provides the generated map image to the user side instead of the location information.

In some embodiments, at S209, the antitheft unit 133 may determine if it is a preset time (e.g., 10:00 P.M) and if so, release the antitheft mode.

The foregoing exemplary embodiments and advantages are merely exemplary and are not to be construed as limiting the present invention. The present teaching can be readily applied to other types of apparatuses. Also, the description of the exemplary embodiments of the present inventive concept is intended to be illustrative, and not to limit the scope of the claims, and many alternatives, modifications, and variations will be apparent to those skilled in the art.

What is claimed is:

1. A mobile phone which is connected to a mobile communication network and provides a mobile communication service, the mobile phone comprising:
a global positioning system (GPS) receiver which generates current location information of the mobile phone;
a movement detecting unit which generates movement information and posture information of the mobile phone;
a built-in camera which photographs in a forward direction;
a storage medium which stores information regarding a user's registered geographical range;
an antitheft unit which enters antitheft mode if the current location information received from the GPS receiver is outside the user's registered geographical range and if the mobile phone is not moved for a first set time based on determination of the information provided by the movement detecting unit, and releases the antitheft mode if a predetermined release command is received from a user; and
a data processing unit which transmits to a user side the location information received from the GPS receiver and images photographed by the camera at interval of a second set time during the antitheft mode.

2. The mobile phone of claim 1, wherein the data processing unit generates a map image using map data stored in the storage medium, in which a location corresponding to the location information is indicated on the map image, and transmits the generated map image to the user side instead of the location information.

3. The mobile phone of claim 1, wherein the antitheft unit outputs a predetermined alarm sound if determining that the mobile phone is moving based on the information provided by the movement detecting unit during the antitheft mode.

4. The mobile phone of claim 3, wherein the antitheft unit determines if the mobile phone is within a set angle range based on determination of the information provided by the movement detecting unit during the antitheft mode, and
if the mobile phone is determined to be positioned within the set angle range, the data processing unit causes the camera to photograph in a forward direction, carries out image processing on the photographed images and stores in the storage medium an image from which facial information is detected.

5. The mobile phone of claim 1, further comprising an operation starting unit which generates an event which controls so that the antitheft unit is called to start operating, if a call is connected to a preset sender telephone number or a text message including a preset text string is received from the sender telephone number, wherein
the antitheft unit does not constantly operate but initiate operation in response to the event.

6. An antitheft method of a mobile phone which is connected to a mobile communication network and provides a mobile communication service, the antitheft method comprising:
entering antitheft mode if current location information received from a GPS receiver is outside a user's registered geographical range and if the mobile phone is not moved for a first set time based on determination of information provided by a built-in movement detecting unit, and maintaining the antitheft mode until a predetermined release command is received from a user; and
transmitting to a user side the location information received from the GPS receiver and images photographed by a built-in camera at interval of a second set time during the antitheft mode.

7. The antitheft method of claim 6, wherein the transmitting comprises generating a map image using map data stored in a storage medium, in which a location corresponding to the location information is indicated on the map image, and transmitting the generated map image to the user side instead of the location information.

8. The antitheft method of claim 6, further comprising outputting a predetermined alarm sound if determining that the mobile phone is moving based on the information provided by the movement detecting unit during the antitheft mode.

9. The antitheft method of claim 8, further comprising determining if the mobile phone is within a set angle range based on determination of the information provided by the movement detecting unit during the antitheft mode, and
if the mobile phone is determined to be positioned within the set angle range, causing the camera to photograph in a forward direction, carrying out image processing on the photographed images and storing in the storage medium an image from which facial information is detected.

10. The antitheft method of claim 6, further comprising operation starting step of maintaining the antitheft mode, if a call is connected to a preset sender telephone number or a text message including a preset text string is received from the sender telephone number.
